(19) United States
(12) Patent Application Publication
(10) Pub. No.: US 2002/0120600 A1
(43) Pub. Date: Aug. 29, 2002

(54) System and method for rule-based processing of electronic mail messages

(76) Inventors: Vincent J. Schiavone, Berwyn, PA (US); James H. Koenig, Philadelphia, PA (US); Simson Garfinkel, Cambridge, MA (US)

Correspondence Address: Gregory S. Bernabeo, Esquire, Synnestvedt & Lechner LLP, 2600 Aramark Tower, 1101 Market Street, Philadelphia, PA, 19107-2950, US

(21) Appl. No.: 09/793,263

(22) Filed: Feb. 26, 2001

(51) Int. Cl. G06F 7/00

(52) U.S. Cl. 707/1

(57) ABSTRACT

A method for negotiating an electronic mail transaction. An electronic mail message's mail type specifier is identified. A data store stores data specific to the intended recipient. The data store is referenced and the electronic mail message is processed as a function of the mail type specifier and data retrieved from the data store. The mail may be processed at the recipient's mail client device and the information maintained confidential. The processing may be based upon reference to a rule applicable to that particular message. The rule includes a conditional instruction conditioned upon a result of a logic or other function of recipient profile data. Alternatively, the processing may provide for modification of the content of the message as a function of such recipient profile data. Recipient preferences from multiple recipients may be aggregated and propagated to senders and/or intermediaries to allow for pre-transmission processing of electronic mail messages.

### FIELD OF THE INVENTION

This invention relates generally to the field of electronic mail and particularly to a method and apparatus for rule-based processing of electronic mail messages, e.g. to negotiate transactions, enable automated verification of compliance with privacy, legal, regulatory and/or best practices standards, to perform spam filtering, anonymous profiling, target marketing through dynamic offers, and prioritization and standardization of e-mail to transactions.

### BACKGROUND OF THE INVENTION

Communications networks, such as the Internet, are now being widely used internationally for sending and receiving predominantly textual electronic mail (“e-mail”) messages. While e-mail has long been used for personal matters, it is now being heavily used for marketing and/or commercial (collectively, “commercial”) purposes. The reach of commercial e-mail is often overly broad because e-mail is quickly, easily and inexpensively sent. Typically, minimal, if any, screening is performed to narrow a list of recipients. A common means of sending spam the “dictionary attack.” In this attack, a marketer will have a list of the most common usernames, connect to a mail server, and then attempt to send a message to every username at the connected mail server. For example, john@ is a common username. The marketer might connect to vineyard.net's mail server and attempt to send e-mail to john@vineyard.net, even if the marketer doesn't know for sure if such an account exists. As a result, many individual e-mail users receive unwanted, unsolicited and/or duplicate bulk e-mail typically referred to as “spam”. Such spam may often be unwelcome to the recipient or contain terms/offers or concern subject matter of little or no importance to the recipient. Such messages are of as little value to the sender as to the recipient, since the recipient is unlikely to act in a way that will benefit the sender. While a small amount of spam may be merely a minor annoyance to a user, a large amount of spam can be overwhelming, time-consuming to deal with, and bothersome to the user. Additionally, the sending of numerous unsolicited, unwanted and/or unimportant messages distracts the recipient from the relatively few important ones or makes the recipient generally less responsive to e-mail messages, effectively diluting electronic mail's value as a communications medium. Additionally, there are significant and increasing costs associated with the cost of bandwidth, storage and despoofing absorbed by e-mail service providers and corporate domains. Some electronic mail messages are simply inappropriate for the intended recipients and some recipients wish to reject certain inappropriate mail messages. However, there is no current satisfactory method for ensuring that spam is rejected and/or that mail messages received have value to the recipient. Additionally, there is no satisfactory method for ensuring that only appropriate messages are received by certain recipients.

A simplified explanation of electronic mailboxes, electronic mail addresses, and the operation of a typical e-mail system is provided in U.S. Application No. ______ titled Method and Apparatus for Selective Delivery and Forwarding of Electronic Mail (Attorney Docket No. P24618 USA), filed ______, now U.S. Pat. No. ______, issued ______, the disclosure of which is incorporated herein by reference.

Some techniques are known and used to selectively target unsolicited marketing, customer acquisition and/or other commercial e-mail messages to recipients. For example, e-mail list brokers exist for compiling and/or managing e-mail address lists of recipients having certain identifiable characteristics, interests or other factor shared in common (e.g., subscribers to a magazine, online or offline newsletter and permission-based marketing opt-in lists). These techniques are neither efficient nor private. Many of the lists that are available for such purposes are not effective targeting tools given that many such lists do not contain a significant amount of, if any, personal/demographics information (often, they contain only an e-mail address, not even a name or zip code). Alternatively, a list broker or other intermediary has additional demographic information available regarding all or a portion of the people whose e-mails are contained on its lists, but only reveals aggregate information to the sender. This method better protects each recipient's privacy, but does not necessarily provide a more effective targeting of individual recipients. Yet, if such a list also contains demographic information (or such information can be supplied by a third party source as an overlay of a primary file record), such a list can compromise a recipient's privacy because his or her personal information is known and/or becomes known to the list broker and/or the sender or a source of information which is appended to existing lists of the broker or sender.

Various client-side filtering techniques are known for accepting or rejecting incoming mail messages. These techniques can be used to reduce the number of spam messages received by a recipient but they provide limited protection. For example, mail reader software programs such as Microsoft® Outlook® allow the user to define filters, for refusing receipt of mail based on keywords and/or a sender's identity. Various opt-in and permission based e-mail marketing techniques exist for permitting the recipient to invite e-mail messages relating to certain topics or subject matter. This must be performed repeatedly for each instance in which receipt of mail is desirable or undesirable and is cumbersome to track as the recipient's preferences change. In other words, such techniques have limited effectiveness. There are no satisfactory techniques that reduce spam by providing for customization of e-mail messages to target a specific recipient, and that provide for easy, dynamic control over a recipient's preferences, which may change over time, for receiving e-mail messages of certain types while maintaining their privacy and confidential information.

Presently, e-mail is used as a communications tool but few standards, rules, or laws apply to govern how the e-mail communications medium is used. Yet increasingly, a patchwork of local, federal and international laws, regulations and best practices are being enacted and adopted, many attempting to legislatively eliminate spam and/or marketing and mailing techniques utilized by spam senders. Applicable laws, however, have limited regional application, and knowledge and enforcement of such laws is difficult due to the global nature of the e-mail infrastructure. Moreover, even with respect to laws, regulations and best practices adopted and enacted, there are no satisfactory techniques for ensuring compliance of e-mail messages with applicable standards and/or laws and/or otherwise determining appropriateness of a message for an intended recipient. As a consequence, e-mail anti-spam laws and initiatives are not effective in preventing unwanted messages, including spam, and in some instances, circumscribe, limit or even prohibit rational and/or traditional business and marketing practices of legitimate businesses and e-mail marketers.

### SUMMARY OF THE INVENTION

The present invention provides a system and method for rule-based processing of electronic mail messages. The rules include logic for processing of incoming messages. A common set of rules is used by two or more users of the system. The rule may be associated with messages by default, in an automated fashion, or as the result of a sender's specification, e.g., by including a mail-type specifier in the message. In this manner, logic for processing a message may be separated from the message itself, allowing diverse communications between diverse parties in accordance with a single rule. For example, rules can be structured to require commercial e-mail messages to include mail-type specifiers used as flags for governmental taxation, to conduct auctions among a group by collecting bids via email in an automated fashion and sending an e-mail message to the highest bidder or to all bidders with notification of the present bid, to conduct automated requests for proposals, e.g., allowing vendors to bid on contracts or offer goods at a specified price, an e-mail reply being automatically sent to the lowest cost supplier, to facilitate viral group purchasing, e.g., by circulating an e-mail message until a predetermined number of buyers have agreed to purchase, at which point a reply is forward to the vendor and the sale transactions are completed at a group, discounted rate, and to make dynamic offers, e.g., in advertisements. Additionally, the present invention can be used for filtering, e.g., by requiring incentive payments for receiving email messages or by allowing receipt of a message only if certain laws or standards are complied with. Compliance is determined as a function of user preferences stored in a recipient data store, e.g., at a client device, sender device, or an intermediary's device, such as a trusted authority's device.

Accordingly, the present invention enables an individual user to conduct a complex transaction via e-mail by composing a simple message and specifying processing in compliance with a potentially complex logic-based rule, e.g., a predetermined rule.

### DESCRIPTION OF THE DRAWINGS

FIG. 1 is a flow diagram of an exemplary generic electronic mail transaction in accordance with the present invention;

FIG. 2 is a flow diagram of an exemplary rule-based processing transaction in accordance with a first embodiment of the present invention;

FIG. 3 is a flow diagram of an exemplary recipient-side mail modifying transaction for recipient targeting in accordance with a second embodiment of the present invention, shown from a recipient's perspective;

FIG. 4 is a flow diagram of an exemplary sender-side mail modifying transaction for recipient targeting in accordance with a third embodiment of the present invention, shown from a sender's perspective;

FIG. 5 is a block diagram of an exemplary electronic mail system as known in the prior art; and

FIG. 6 is a block diagram of an exemplary electronic mail transaction system for carrying out the exemplary transactions of FIGS. 1-4, in accordance with one embodiment of the present invention.

### DETAILED DESCRIPTION

Generally, the present invention provides a novel electronic mail transaction system, method and apparatus for automated negotiation of delivery, routing, filtering, modification, compliance checking and/or other actions with respect to electronic mail messages based on a shared rule set. This involves the dynamic processing of electronic mail messages. The processing is performed in accordance with logic set forth in a rule associated with the message. The rule is structured for being carried out in an automated fashion, e.g., by software. For example, the dynamic processing may occur before sending of the mail message, before receipt of the mail message, or before display of the mail message. For example, a particular e-mail message may be processed at the mail client device as a function of a rule applicable to that particular message and, optionally, specific recipient profile data. Alternatively, the rule may be processed at an intermediary, a third party, or upon reply to the sender.

For example, rules may be implemented for a wide variety of applications, including compliance with applicable laws. Accordingly, a mail message can be automatically processed and consequently filtered or routed based on a patchwork of applicable laws, regulations and best practices applicable to the specific sender, receiver and content of the e-mail message. For example, a message may be rejected, and not delivered to the intended recipient, if a recipient's profile data is incompatible with applicable laws for receiving the message, as specified in a rule associated with the message.

In some embodiments, the rule may require modification of the content of the message as a function of such recipient profile data. For example, an electronic mail message may be modified before it is sent, or before it is received, e.g., by adding or deleting certain content, by modifying the message's color, length, etc., or by assigning values to variables within the mail message, such as a bid value incentivizing the recipient to read, act or prioritize the e-mail message being delivered. This dynamic generation of content and/or commercial messages and offers makes the message more interesting, valuable or relevant to each recipient. Accordingly, recipients receive less unwanted mail (e.g. spam) and the mail received is more interesting to the recipient because it is customized to the recipient's preferences. This technique can also be used as a filter to reject spam or other messages, e.g., those not specifying an incentive payment in excess of a predetermined threshold stored in a recipient's profile data. In one embodiment, an incentive payment may be determined dynamically, e.g., to exceed such a predetermined threshold.

Such recipient profile data may be stored at the recipient's communications devices and maintained confidential, or maintained on the recipient's network and/or at a trusted authority, e-mail service provider (ESP), or other third party on a distributed basis. In some embodiments, recipient preference data wherever stored is not intended to in all instances be confidential and, when and where appropriate, may be transmitted from the recipient's computer or data store. In some embodiments, recipient preferences from multiple recipients are aggregated and propagated to senders and intermediaries, such as ISP's and ESPs (collectively, “electronic mail service providers”), which may then process rules as a function of such data.

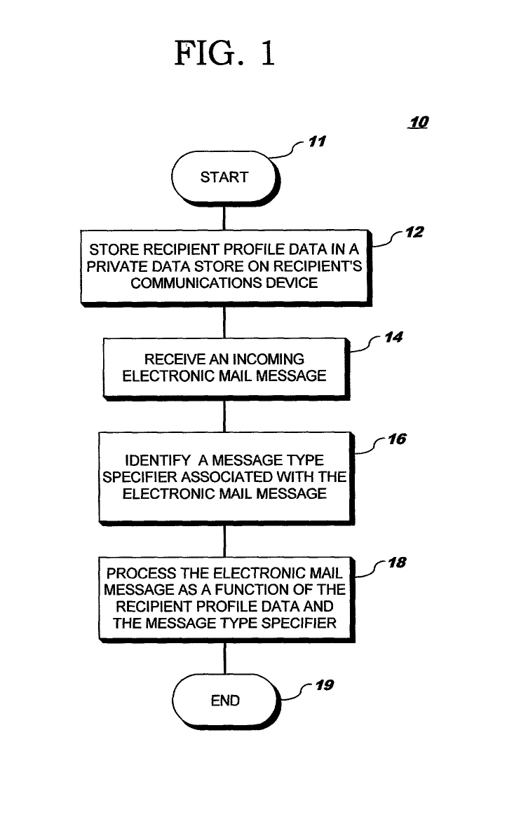

Moreover, the advantages of the present invention can be performed while maintaining confidentiality of a recipient's profile data by storing such data privately, and processing said messages at the recipient's communications device. The present invention is further discussed below with reference to FIGS. 1-7.

FIG. 1 is a flow diagram 10 of an exemplary generic electronic mail transaction in accordance with the present invention. As shown in FIG. 1, the inventive method starts with the storing of recipient profile data in a memory of a recipient's communications device, as shown at steps 11 and 12. The recipient's communications device may be any communications device capable of receiving electronic mail or instant messages, such as a general purpose computer running mail client software, a Web-enabled wireless telephone, a wireless personal digital assistant such as a Palm VII® device, a pager, etc. For discussion purposes, the following discussion considers a general-purpose computer running mail client software.

For example, the recipient profile data may be stored in a recipient data store 120 as shown in FIG. 6. FIG. 6 is a block diagram of an exemplary electronic mail system for carrying out the exemplary transactions of FIGS. 1-4, in accordance with one embodiment of the present invention. It should be noted that the Figures referred to herein show separation of components in a fashion meant to emphasize logical, functional differences between components, although no actual separation is implied or necessary.

Preferably, the data stored in the recipient data store 120 is grouped into at least two classes, public preference data which may be freely communicated from the recipient's data store, and private preference data which will never be communicated from the recipient's data store without the recipient's express approval to do so. Optionally, the classification of data as public versus private may be reviewed and/or determined by the recipient. In the example of FIG. 6, there is a public preference data store 120a for storing public preference data, a private profile data store 120b and a private commerce data store 120c. For example, the private profile data store 120b may include information such as name, address, telephone number, age, sex, race and social security number. This private and public preference data may be compiled, for example, during the recipient's completion of a questionnaire. The private commerce data store may contain credit card and bank account numbers, etc. Such data is preferably generic in that it does not apply to a specific transaction, specific sender, or specific message. Rather it is generic information that is specific to the recipient, and which may be relevant in an undetermined and diverse number of transactions.

Next an incoming electronic mail message is received, as shown at step 14 in FIG. 1. For example, the message may be received by a local mail client 152 (i.e. software running on the recipient's mail client computer 150), as shown in FIG. 6. Mail client software is well known in the art. In accordance with the present invention, the local mail client is configured to retrieve mail from an electronic mail service provider as is known in the art and to communicate with a recipient compliance engine 154.

A message-type specifier of the electronic mail message is next identified, as shown at step 16 of FIG. 1. For example, the message-type specifier may include a keyword or a seal graphic/image object (indicating compliance with certain laws, regulations and/or best practices standards) contained in the viewable portion, e.g., body, subject line, etc., of the message, or any known type of “flag”. In one embodiment, the message-type specifier is a datastring, such as an alphanumeric or ASCII character string, stored in a special field of the message's header information. Such header information is typically hidden from the recipient. The concept of inclusion of such a special field in the header information to provide a message-specific message-type specifier is within the scope of the present invention.

For example, the message type specifier may be indicative of content of the electronic mail message, e.g., if the message is of a personal, confidential nature, the specifier may be “CONFIDENTIAL”, if the message relates to newsletters, the specifier may be “NEWS”, if it relates to the billing statements, it may be “BILLS”; if it relates to advertising, the specifier may be “ADV”. For example, the message type specifier may be assigned by affirmative action of the sender, e.g., by typing the specifier in the subject or body of the message. This requires no special software on the part of the sender. Alternatively, the specifier may be assigned to and associated with a message, e.g., by storing it in the message, in an automated way by dynamic specifier generator software 180 stored at the sender's computer and including any suitable logic for doing so. For example, this may be incorporated into the mail composition software. Preferably, the mail type specifier is associated with the message by storing the mail type specifier in header information of the electronic mail message. For example, the dynamic header generator 180 may scan text of the message and associate an appropriate keyword with the message. Alternatively, the author of the mail message may specify a mail type specifier to be associated with the message, e.g., by selection from a menu, the associating being performed by the dynamic header generator 180. Programming techniques for carrying out these steps are well known in the art.

It is advantageous that the sender and recipient share knowledge of a common set of message type specifiers and that the mail type specifier for a given message is one selected from the common set. For example, the set may be established and/or maintained by a trusted third-party intermediary, i.e. a trusted authority.

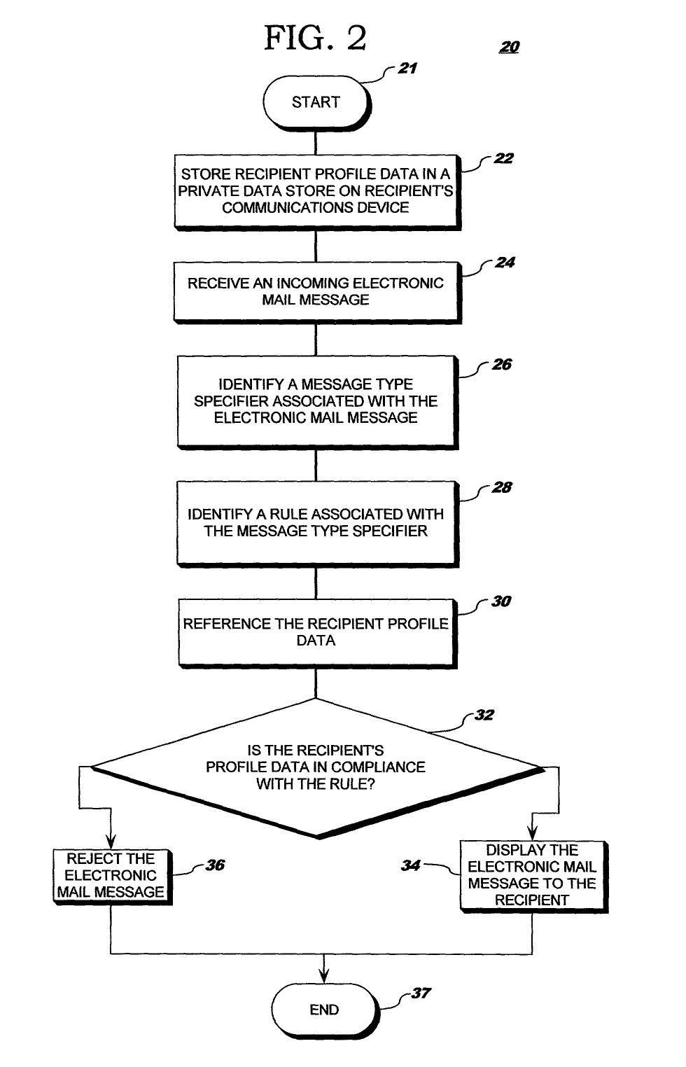

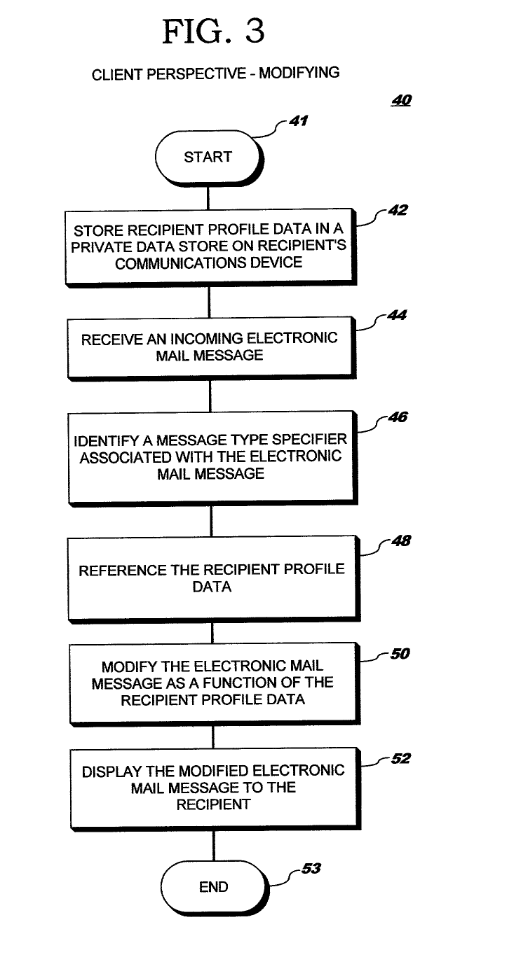

Finally, the method ends with further processing of the electronic mail message as a function of the recipient profile data and the message type specifier, as shown at steps 18 and 19 of FIG. 1. This processing step may take many forms. Illustrative examples are discussed below with reference to FIGS. 2 and 3.

FIG. 2 is a flow diagram 20 of an exemplary rule-based processing transaction in accordance with a first embodiment of the present invention. As shown in FIG. 2, recipient profile data is stored on the recipient's communications device, an incoming electronic mail message is received, and a message type specifier associated with the electronic mail message is identified, as shown at steps 21-26 and as described above in reference to FIG. 1 and steps 11-16.

For example, consider that the message type specifier identified in step 26 is “COPPA”. Such a message type specifier indicates that the sender intends the message to be delivered in accordance with The Children's Online Privacy Protection Act, a law applicable in the United States (“US”) which forbids delivery of commercial electronic mail communications to children aged thirteen (13) and under unless a parent has given prior consent. For example, a rule may be constructed to determine compliance with any applicable law, rule, regulation, code, best practice, etc. of any region, e.g., local, state, federal, foreign, etc. (“regional law”). Consequently, a sender could select several different rule sets to automate their compliance with selected US federal and local laws and regulations and, if desired, varying laws and regulations enacted by the European Union and elsewhere globally.

Steps 28-34 of FIG. 2 are illustrative of the processing shown at step 18 in FIG. 1. As shown at step 28 in FIG. 2, a rule associated with the message type specifier is identified. The rule controls how the e-mail message will be processed. For example, the rule may be contained with the message. Alternatively, the recipient's communications device may communicate via a communications network to obtain a copy of the rule from a central source, such as a third party trusted intermediary. In this example, the rule is obtained from a data store of rules 155 stored in a memory of the recipient's communications device. Such a data store is preferably periodically updated by a third party trusted intermediary responsible for defining rules, maintaining and updating rules, approving proposed rules, and distributing such rules to senders and recipients known to the trusted intermediary.

In the example of FIG. 2, consider that the rule for COPPA indicates that the rule applies only to recipients living in the US, and that the mail message should be delivered to a U.S. recipient only if the recipient is over the age of 13, because the sender has no prior consent to communicate with any recipients.

The recipient's profile data is then referenced, as shown at step 30, and it is determined whether the recipient's profile data is in compliance with the rule, as shown at step 32. These steps may be carried out by software stored on the recipient's communications device for this purpose, e.g., by the recipient compliance engine 154 shown in FIG. 6. Programming techniques for implementing such software is well known in the art. Referencing the profile data at the recipient's communications device is advantageous because the message can be sent to the recipient without revealing any information about the recipient to the sender or an intermediary, unlike current methods which provide demographics type information to the sender for use in a pre-sending screening process. Accordingly, the present invention preserves the privacy of recipients while providing enhanced preference-based filtering, targeting and/or compliance.

In the example of FIG. 2, consider that the recipient's profile data indicates that the recipient lives in the US and is 45 years of age. Accordingly, it is determined that the recipient's profile data is in compliance, i.e., compatible, with the applicable rule in step 32 and the electronic mail message is delivered to the recipient, e.g. placed in the recipient's electronic “inbox” and/or displayed to the recipient, as shown at step 34. The transaction then ends, as shown at step 37. For example, the same message sent to a 10 year old in France could result in a determination of compliance and delivery of the message because the rule (and COPPA law) is applicable only to residents of the US. Compliance with local laws is thereby ensured.

If the recipient's profile data is determined not to be in compliance with the applicable rule in step 32, then the electronic mail message is rejected, as shown in step 36, and the transaction ends, as shown at step 37. Alternatively, the message may be received and deleted, or returned to the sender, etc. This can preserve the privacy of the recipient. For example, unless the message is returned to the sender, the sender won't know whether the recipient is under the age of 13.

This rule-based transaction makes electronic mail a negotiated transaction and controls further processing of e-mails, e.g., after a message is composed and provides for enhanced protection and privacy of users of the system. As used herein, a “transaction” refers to any e-mail message having a predetermined structure and/or any processing of an e-mail having predetermined structure. Additionally, the infrastructure provides for widespread usage of a common, standard set of rules which interacts with generic profile information. Accordingly, rules can be added, deleted and/or revised easily without a need for revisions to the data stored in the private profiles of individual users. Thus, nearly limitless transaction types may be enabled.

For example, transactions in accordance with the present invention may include work flow processing transactions, e.g., by providing a rule requiring approval and/or handling of a given electronic mail message by more than one recipient and/or according to a predetermined deadline schedule. For example, a company-developed rule may require internal approval (e.g., by clicking an appropriate button or typing OK, etc.) from a purchasing agent, a supervisor, an accountant, and a vice-president before a purchase order is forwarded to a vendor. Accordingly, although the mail message is prepared by the purchasing agent and addressed to the vendor, the electronic mail message will be processed according to the rule and forwarded to each individual for approval before the message is able to be sent to the vendor.

A rule could also be constructed to conduct auctions among a group by collecting bids via email in an automated fashion. For example, an e-mail message describing an item to be auction could be sent to a group of individuals according to an auction rule. The auction rule could specify that a message is sent to each of the other individuals every time any individual places a bid by e-mailing the seller, although the message is addressed only to the seller, and sending an automated e-mail message (“YOU WON!”) to the highest bidder after expiration of a predetermined auction period (e.g. a predetermined length of time or number of bids).

A rule could be constructed to conduct automated requests for proposals. For example, a single e-mail from a purchasing agent could be addressed to multiple vendors and soliciting bids on contracts or for goods. The rule could require purchase from the lowest cost supplier, and could require waiting until replies had been received from all vendors, required comparison of the bids, cause an email message identifying the lowest bid and lowest cost supplier to be sent to the purchasing agent and the rule trigger the automatic sending of a message to the electronic mail address of the lowest cost supplier confirming the purchase without further action on the part of the purchasing agent (unless a consent or confirmation was otherwise built into the rule).

A rule could be constructed to facilitate viral group purchasing. For example, a vendor could send an e-mail stating “I'll sell these CD players for $39 each if you can get 20 buyers” and specifying a rule requiring the e-mail message to await 20 buyers' indications of agreement to purchase for $39 before automatically sending a reply message to the vendor (and each of the other purchasers) indicating that an aggregate of 20 buyers had been obtained, including their shipping address and credit card information gathered from their personal profile data, etc. For example, the e-mail message could be circulated until a predetermined number of buyers have agreed to purchase, at which point a reply is forward to the vendor and the sale transactions are completed at a group, discounted rate.

By way of further example, rules could be constructed to facilitate an e-mail notary transaction, e.g., by implementing a rule requiring notary-like certification and authentication by a third party or process prior to sending of an e-mail message. Similarly, such a certification and authentication could be used to conduct election voting via an e-mail or other messaging platform, e.g., by implementing a rule requiring a recipient's personal profile data to be accessed to authenticate/verify the identify the individual and the corresponding voting district, and further requiring access via a communications network of data indicating candidates for the recipient's voting district, etc.

In many instances, the logic or instructions in the rule are conditional in that they require an action to be performed before a next instruction occurs, e.g., awaiting approval from a purchasing agent before forwarding the message to a supervisor for approval, etc.

It should also be noted that the present invention can be used for more than just the most common forms of electronic mail messages. For example, the present invention may also advantageously be used for instant messages such as AOL's Instant Messenger messages or ICQ's instant messages. For example, instant messages can be sent as COPPA compliant by specifying a COPPA rule as associated with the instant messages. Any incoming instant messages would then be check against the recipient profile information in accordance with the COPPA rule to determine whether the instant message should be delivered or rejected (for non-compliance of the recipient data with the rule). Additionally, the rule-based processing can be used for outgoing requests or transmissions, event such transmission which are not electronic mail transmissions. For example, a web browser request for data from a particular URL could be processed in accordance with a rule and a recipient profile. For example, a child's recipient profile may indicate his young age (under 21) and the parent's recipient profile may indicate his older age (over 21), and a rule may be specified as applicable to all web browser requests. For a web browser request having an associated rule (e.g., a URL pointing to an adult content website may be associated with an “OVER 21 YEARS OF AGE” rule), and the rule will be checked against the outgoing browser request and blocked if the recipient profile data is not in compliance with the rule. In other words, the web browser request is processed as a function of the rule. For example, the parent may be able to obtain access while the child will not.

In accordance with the present invention, all of these examples require further processing of an e-mail message after the message's composition or receipt. This adds a layer of trust to the system when the third party intermediary controls the rule base and can correct errors and reject unacceptable or inappropriate rules.

Rules for which compliance cannot be determined due to a lack of certain information in the private data store may be handled, for example, by rejecting the message or by prompting the recipient to supply the missing information, along with a prompt to optionally add such information to the private data store. This also allows the third party intermediary to ensure compliance with the system, e.g., by implementing rules requiring a digital signature to communicate within the system, and requiring such digital signature to be based on a digital certificate revocable by the trusted third-party intermediary upon abuse of the system, etc. For example, a rule could be implemented requiring all unsolicited commercial e-mail (e.g., spam, UCE) to contain a “UCE” rule specifier. This can be used by the recipient for filtering, e.g., to block such messages and/or create sender accountability. It also allows for processing and/or handling in a prescribed way, e.g., requiring payment of a governmental tax. For example, messages containing such rule specifiers may be tracked, sorted by sender, and the sender's identities and volumes of UCE mail reported to governmental authorities or to the senders for taxation purposes.

An SMTP proxy may be advantageously configured so that all outgoing email messages are automatically signed using a private key that is specially registered to a sender (marketer). Each e-mail message must be individually signed because each message is different, since e-mail messages tend to have “unsubscribe” links at their bottom.

In systems in which e-mail messages are processed by rules, it is advantageous to digitally sign the rules in the header of each message. This provides the advantage of guarding against accidental or malicious modification of the rules. It also verifies to the recipient that the e-mail were in fact deals offered by the sender of the email.

Senders who do not comply can have system privileges and/or a digital signature revoked. Unsigned messages may be field in a special mailbox. Rules requiring digital signatures effectively preclude use of the system by parties who fail to comply with system rules. Accordingly, complete sender accountability virtually eliminating spam and affording recipients control of their inbox can be created on a network of all subscribing users.

FIG. 3 is a flow diagram 40 of an exemplary recipient-side mail modifying transaction for recipient targeting in accordance with a second embodiment of the present invention, shown from a recipient's perspective. In the example of FIG. 3, the recipient profile data is used to modify the electronic mail message at the recipient's communications device. This is advantageous because the recipient profile can be maintained at the client's communications device, personalized, customized electronic mail messages may be delivered to the recipient without disclosing to the sender or other parties sensitive information, such as salary information.

As shown in FIG. 3, the recipient profile data is stored on the recipient's communications device, an incoming electronic mail message is received, and a message type specifier associated with the electronic mail message is identified, as shown at steps 4146 and as described above in reference to FIG. 1 and steps 11-16. For example, consider that the message type specifier identified in step 46 is “ADV”. Such a message type specifier indicates that the message is an advertisement or promotional offer from a party with whom the recipient does not have a previous relationship (if a previous relationship exists, such e-mail could be classified or reclassified separately, e.g, as a Customer Relationship Managment (CRM) e-mail, a newsletter or promotion from an approved sender, etc.).

Steps 48-52 of FIG. 3 are illustrative of the processing shown at step 18 in FIG. 1. As shown in step 48, the recipient's profile data is then referenced. The electronic mail message is then modified as a function of the recipient profile data, as shown at step 50 in FIG. 3. This modification step may require reference to a rule or instruction. Such a rule may advantageously be a part of the message, e.g., a hidden part. Such a rule or instruction may be composed by the sender and may be applicable to only the corresponding mail message.

In one embodiment, the message is modified by altering, i.e, assigning a value to, recipient dependent variables in the electronic mail message. For example, this may result in a “dynamic offer”—a message that contains that contains several versions or elements that can be constructed and/or modified based on a predetermined rule set that negotiates the delivery, filtering and form of the offer based on the e-mail message's confidential “sniffing” of the recipient's private profile data 120b (by Compliance engine 154) prior to the delivery to and/or opening of such message by an intended recipient.

For example, consider an automotive dealer's customer acquisition promotion in the form of an e-mail-based dynamic offer sent to a list of wealthy individuals. The dynamic offer is modified for each specific recipient based on a rule that modifies the offer and/or selects a version thereof as a function of the “sniffing” of the recipient's private profile data. For example, the e-mail may arrive at the place the recipient's private profile data is stored (preferably, on the recipient's communications device, but in an alternate embodiment, at the recipient's network, ISP/ESP, a trusted authority or other third party if the confidential recipient information is stored remotely and/or on a distributed basis) and confirms that the recipient has an income in an appropriate range for delivery of the message. As a next step, the specific income range of the recipient may determine whether a domestic or a more expensive foreign sports car is offered by the e-mail message in accordance with the rule. Yet, if the recipient's private profile data also has information indicating the presence of two or more children in the recipient's household, the offer may alternatively feature a family vehicle such as a minivan or a sport-utility vehicle. Further, if the recipient's private profile data indicates that the recipient has poor credit or excessive debt, the offer may be modified to offer a different car, different credit terms, a different price of the offered vehicle and/or the offer may not be presented to the recipient at all. As a consequence, true one-to-one marketing can be achieved based on confidential and private information—anonymous profiling.

Finally, the method ends with listing of the modified electronic mail message in the recipient's electronic inbox of the recipient's mail reader software and/or display of the message to the recipient, as shown at steps 52 and 53 of FIG. 3.

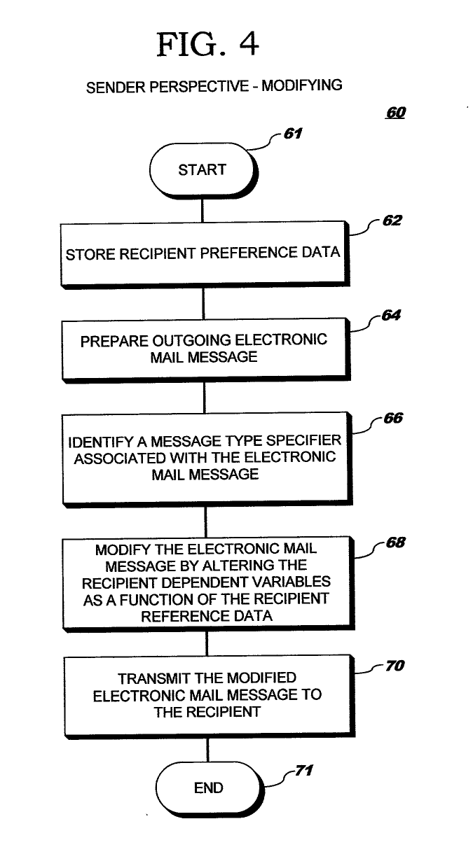

FIG. 4 is a flow diagram 60 of an exemplary sender-side mail modifying transaction for recipient targeting in accordance with a third embodiment of the present invention, shown from a sender's perspective. In this embodiment, the mail message is modified at the sender's device, before the message is sent via a communications network. As shown in FIG. 4, the method starts with the storing of recipient preference data in a memory of a commercial mail sender's computer, e.g., a mail client computer as shown at steps 61 and 62. The recipient preference data includes information that the recipient agrees to share with third parties and/or to be stored confidentially at a trusted authority or otherwise on a distributed basis.

In this example, the sender stores aggregate preference data, e.g. in an aggregate preference data store 160 as shown in FIG. 6. Such aggregate preference data is periodically transmitted from a third party intermediary, e.g., a trusted third party, which receives preference data from individual recipients, collates the data, and periodically transmits the data to senders known to the third party intermediary. Implicitly, this step involves receiving aggregate recipient preference data reflecting each of a plurality of recipients' preferences relating to mail messages having certain characteristics.

In the example of FIG. 4, the sender next prepares an outgoing electronic mail message intended for delivery to a recipient, as shown at step 64. This step may be performed using mail composing and/or mail transmission software (collectively “mailing software”) as shown at 170 in FIG. 6 and is well known in the art. In accordance with the present invention, the mailing software is specially configured to communicate with the aggregate recipient preference data store 160.

A message type specifier is next identified, as shown at step 66. For example, the message type specifier may simply identify the mail message as a dynamic or modifiable email message. Alternatively, the message type specifier may help in identifying a rule or instruction for modifying the mail message. In this example, the rule or instruction may be stored by the sender (or accessible to the trusted authority or another third party, if appropriate) and need not be included in the message.

The electronic mail message is then modified by altering, i.e, assigning a value to, the recipient dependent variables as a function of the recipient preference data, as shown at step 68. This may be aggregate recipient preference data or recipient specific preference data. This may result in modification of either the body or header information of the message. In other words, the result of the modification depends upon the recipient preference data specific to the intended recipient(s) of the message. Implicitly, this step involves referencing the aggregate recipient preference data store 160.

Finally, the method ends with processing of the electronic mail message by transmitting the electronic mail message to the recipient, as shown at steps 70 and 71 of FIG. 4.

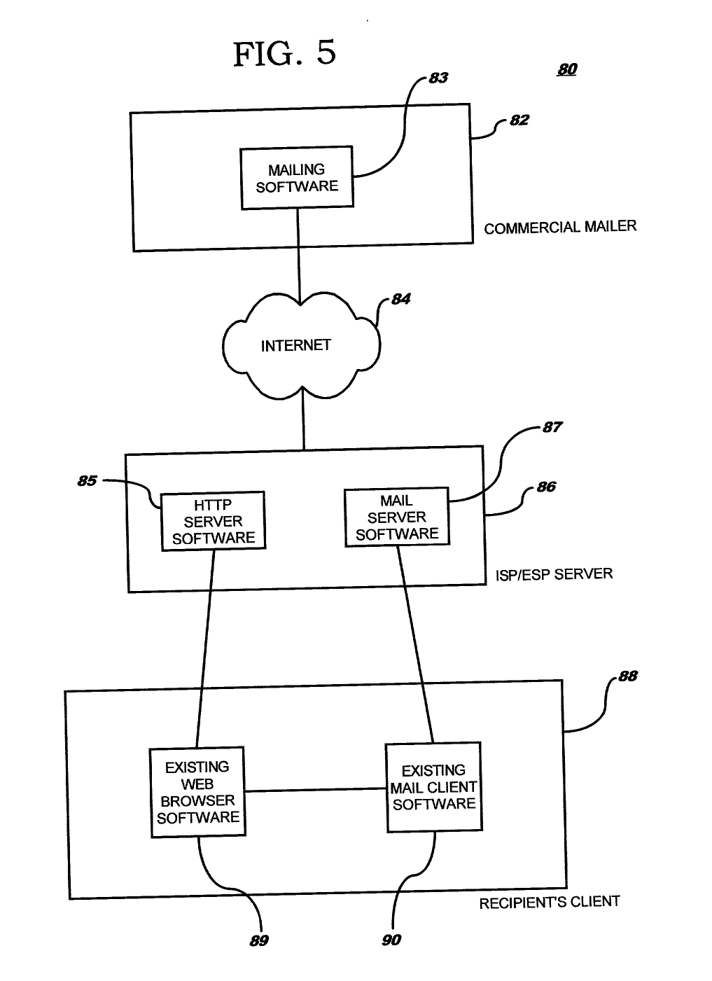

FIG. 5 is a block diagram of an exemplary electronic mail system as known in the prior art. As shown in FIG. 5, a sender, such as commercial mailer 81, has mailing software 82 capable of communicating via a communications network, such as Internet 84, to a recipient's communications device 92, e.g., via an Internet/E-mail Service Provider's (ISP/ESP) server computer 86. The ISP/ESP server computer 86 stores and runs HTTP server software 88 and mail server software 90 as is well known in the art. The recipient's client communications device 92 stores and runs web browser software 94 and mail client software 96 capable of communicating with the ISP/ESP server 86.

The method of the present invention may be implemented through the use of one or more communications devices, e.g., personal computers, having typical hardware and/or specially configured software. FIG. 6 is a block diagram of an exemplary electronic mail transaction system for carrying out the exemplary transactions of FIGS. 1-4, in accordance with one embodiment of the present invention.

As shown in FIG. 6, a message may be prepared by a commercial mailer (sender) 182 by preparing a messaging using mailing software 170 and including a mail-type specifier in the message, e.g. by specifying a mail-type specifier selected from a list of shared specifier. The specifier is embedded in the message by header generator 180. Optionally, the message may be modified or filtered as a function of data stored in an aggregate public preference database 160, e.g., to reduce the number of recipients or modify the message as a function of recipient profile data stored therein.

The message is transmitted over a communications network such as Internet 84 to an intermediary such as the intended recipient's ISP/ESP server 186, as is well known in the art.

The server 186 includes HTTP and mail server software as is well known in the art. The recipient's communications device 150 stores and runs existing web browser and web mail software 89 and existing mail client software 90 as is well known in the art. Additionally, the recipient's communications device 150 stores and runs local HTTP server software 160, local mail client 152 and local mail server 156 software, and a recipient compliance engine 154. The local mail client 152 is configured to retrieve mail messages from the ISP/ESP server 186 and to communicate with the recipient compliance engine 154. The recipient compliance engine 154 is configured to identify a rule associated with the message, including referencing a rule base 155 as necessary, and to process the rule, e.g., by referring to public preference data 120a, private profile data 120b and/or private commerce data 120c stored in the recipient client's data store 120. For example, the recipient compliance engine may reference private profile data and modify the message in accordance with the rule as a function of the recipient's profile data. The recipient compliance engine 154 may store transaction data in a transaction data data store 158, which may be reference by a third party such as trusted authority 200's accounting engine 220 for monitoring such transactions, e.g., for advertising revenue purposes.

The recipient compliance engine 154 then communicates the processed mail message to the local mail server 156. The existing mail client software 90 is configured to retrieve messages from the local mail server 156 rather than from the ISP, as is typically the case. The provision of a local mail client and local mail server on a client device is generally known in the art, e.g., in some UNIX workstations and/or in Windows environments in connection with virus protection software, for providing a break in the processing of e-mail messages at which point further processing can take place. In the present invention, the further processing involves the processing of e-mail messages in accordance with rules as a function of recipient preference data, etc. Similarly, a local HTTP server 162 is provided at the client device 150 for communicating transaction data to the transaction data store 158, e.g., to track click-throughs to websites, etc.

In accordance with an alternate embodiment of the present invention, the rule base 155 may also or alternatively be stored at the commercial mailer, trusted authority and/or another third party and referenced as necessary via a communications network. In another alternate embodiment, a recipient compliance engine may reside at commercial mailer, trusted authority and/or another third party to perform the processing of the rules and collection of recipient preference data, as necessary.

It should be noted that the present invention can also be used for filtering purposes. For example, a recipient's profile data may contain time-based limitations for receiving electronic mail, which may be useful for filtering purposes. For example, a recipient may include in the recipient profile data that for a period of two months, e.g. after purchasing a house, the recipient wishes to receive sale offers relating to purchases of new homes, or home furnishings, etc. The rule can be used to reject or discard the electronic mail message, e.g. before viewing by a recipient, if the appropriate information is not contained in the recipient's profile data. Advantageously, the filtering can be performed at the recipient's communications device and the sender need not have knowledge of the recipient's preferences.

It is noted that the present invention may be advantageously combined with a dynamic prioritization system and/or categorization system such as that disclosed in U.S. application Ser. No. ______ titled Method And Apparatus For Dynamic Prioritization of Electronic Mail Messages (Attorney Docket No. P24773 USA), filed ______, now U.S. Pat. No. ______, issued ______, or a spam routing system such as that disclosed in U.S. application Ser. No. ______ titled Method And Apparatus For Selective Delivery And Forwarding of Electronic Mail (Attorney Docket No. P24618 USA), filed ______, now U.S. Pat. No. ______, issued ______, the disclosures of which are incorporated herein by reference. Additionally, the present invention may be advantageously combined with methods and apparatuses for rule-based processing of electronic mail messages as disclosed in U.S. application Ser. No. ______ titled Electronic Mail Transaction System (Attorney Docket No. P24526 USA), filed ______, now U.S. Pat. No. ______, issued ______, and U.S. application Ser. No. ______ titled Reply Based Electronic Mail Transactions (Attorney Docket No. P24763 USA), filed ______, now U.S. Pat. No. ______, issued ______, the disclosures of which are incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for rule-based processing of electronic mail messages, said method comprising:
(a) identifying a mail type specifier associated with an electronic mail message intended for delivery to a recipient;
(b) referencing a data store associated with said recipient, said data store storing data specific to said recipient; and
(c) processing said electronic mail message as a function of said mail type specifier and data retrieved from said data store.

2. The method of claim 1, further comprising the step of:
(d) storing data in said data store, said data store being stored on said recipient's communications device.

3. The method of claim 1, wherein said mail type specifier comprises a content-based identifier of said electronic mail message.

4. The method of claim 1, wherein said mail type specifier comprises a datastring stored in a body portion of said electronic mail message.

5. The method of claim 1, wherein said mail type specifier comprises a datastring stored in header information of said electronic mail message.

6. The method of claim 1, wherein said mail type specifier comprises an object stored in said electronic mail message.

7. The method of claim 1, wherein said mail type specifier is selected by a sender of said electronic mail message.

8. The method of claim 7, wherein said mail type specifier is typed by a sender of said electronic mail message.

9. The method of claim 7, wherein said mail type specifier is included in said electronic mail message responsive to a sender's selection of a mail type specifier from a menu.

10. The method of claim 1, wherein step (c) comprises the steps of:
(e) identifying a rule associated with said message type specifier; and
(f) determining whether said recipient's profile data is in compliance with said rule.

11. The method of claim 10, wherein step (e) comprises referencing a database stored at said recipient's communications device.

12. The method of claim 10, wherein said profile data comprises identification information specific to said recipient.

13. The method of claim 10, wherein said rule comprises a conditional instruction, said conditional instruction being conditioned upon a result of a function of said profile data, said function being specified by said rule.

14. The method of claim 13, wherein said rule determines compliance with a regional law.

15. The method of claim 13, wherein said conditional instruction comprises display of said electronic mail message only if certain data is stored in said profile data.

16. The method of claim 1, wherein step (c) comprises the steps of:
(g) modifying said electronic mail message as a function of said profile data; and
(h) displaying said electronic mail message.

17. The method of claim 13, where step (c) comprises the step of:
(i) preventing display of said electronic mail message to said recipient.

18. A method for recipient targeting of electronic mail, said method comprising:
(a) receiving aggregate recipient preference data reflecting each of a plurality of recipients' preferences relating to mail messages having certain characteristics;
(b) identifying a mail type specifier of an electronic mail message intended for delivery to a recipient;
(c) referencing said aggregate recipient preference data to identify preference data specific to said recipient;
(d) processing said electronic mail message in accordance with said preference data specific to said recipient.

19. The method of claim 18, wherein step (d) comprises the steps of:
(e) modifying said electronic mail message as a function of said preference data specific to said recipient; and
(f) transmitting said electronic mail message to said recipient.

20. The method of claim 19, wherein a body of said electronic mail message is modified in step (e).

21. The method of claim 19, wherein header information of said electronic mail message is modified in step (e).

22. The method of claim 18, further comprising the step of:
(g) associating said mail type specifier with said electronic mail message, step (g) being performed before step (b).

23. A method for rule-based processing of electronic mail messages, said method comprising:
(a) identifying a rule associated with an electronic mail message intended for delivery to a recipient;
(b) processing said electronic mail message as a function of said mail type specifier and data retrieved from said data store.

24. The method of claim 23, wherein said rule comprises logic for transmitting an electronic mail reply responsive to a user's action.

25. The method of claim 24, wherein said user comprises said recipient.

26. The method of claim 24, wherein said user comprises an individual other than said recipient.

27. The method of claim 23, wherein said rule comprises logic for transmitting an electronic mail reply responsive to multiple users' actions.

28. The method of claim 27, wherein each of said users' actions comprises placing of a bid in an auction.

29. The method of claim 27, wherein each of said users' actions comprises expression of agreement to purchase a product.

30. The method of claim 29, wherein said logic comprises an instruction for transmitting said electronic mail reply to a vendor after a predetermined number of users' expression of agreement to purchase a product.

31. The method of claim 27, wherein each of said users' actions comprises expression of agreement to sell a product at a user-specified price.

32. The method of claim 31, wherein said logic comprises an instruction for transmitting said electronic mail reply to a low-cost supplier of said users, said low-cost supplier specifying a lowest user-specified price.

33. A method for rule-based processing of electronic mail messages, said method comprising:
(a) identifying a rule associated with an electronic mail message intended for delivery to a recipient, said rule specifying logic for processing said electronic mail message;
(b) receiving said electronic mail message; and
(c) processing said electronic mail message as a function of said rule.

34. The method of claim 33, wherein said electronic mail message is an instant message.

35. A method for rule-based processing of web browser requests, said method comprising:
(a) identifying a rule associated with web browser requests, said rule specifying logic for processing said web browser requests;
(b) identifying a web browser request; and
(c) processing said web browser request as a function of said rule.

36. The method of claim 35, wherein said rule requires reference to a data store associated with said user, said data store storing data specific to said recipient, and wherein said rule comprises logic for processing said web browser request as a function of data stored in said data store.

37. The method of claim 36, wherein said data store stores data reflecting an age of said user.

38. An electronic mail system for negotiation an electronic mail transaction, said electronic mail system comprising:
a trusted authority computer comprising:
a central processing unit;
a memory operatively connected to said central processing unit;
a telecommunications device operatively connected to said central processing unit and capable of communicating via a communications network;
a first program stored in said memory and executable by said central processing unit for identifying a mail type specifier associated with an electronic mail message intended for delivery to a recipient;
a second program stored in said memory and executable by said central processing unit for referencing a data store associated with said recipient, said data store storing data specific to said recipient; and
a third program stored in said memory and executable by said central processing unit for processing said electronic mail message as a function of said mail type specifier and data retrieved from said data store.

39. The electronic mail transaction system of claim 38, further comprising:
a fourth program stored in said memory and executable by said central processing unit for identifying a rule associated with said message type specifier; and
a fifth program stored in said memory and executable by said central processing unit for determining whether said recipient's profile data is in compliance with said rule.

40. The electronic mail transaction system of claim 38, further comprising:
a sixth program stored in said memory and executable by said central processing unit for modifying said electronic mail message as a function of said profile data; and
a seventh program stored in said memory and executable by said central processing unit for displaying said electronic mail message.

41. A method for distributing electronic mail comprising the steps of:
(a) storing acceptance criteria for delivery of electronic mail to a recipient's electronic mailbox;
(b) identifying delivery criteria for delivering electronic mail sent by a sender;
(c) receiving an electronic mail message sent by said sender and intended for possible delivery to said user;
(d) comparing said acceptance criteria to said delivery criteria; and
(e) processing said message to deliver said message to said mailbox only if said acceptance criteria is compatible with said delivery criteria.

42. The method of claim 41, wherein said acceptance criteria is generic recipient profile data.

43. The method of claim 42, wherein a rule comprises said delivery criteria and logic for processing said message.

44. The method of claim 1, wherein said processing in step (c) is performed at a recipient's communications device.

45. The method of claim 1, wherein said processing in step (c) is performed at a sender's communications device.

46. The method of claim 1, wherein said processing in step (c) is performed at an intermediary's device.

47. The method of claim 1, wherein said processing in step (c) comprises storing said messages in a designated inbox.

48. The method of claim 1, further comprising the step of:
(d) revoking a digital certificate of a sender for failure to comply with an applicable rule.

49. The method of claim 1, wherein said mail-type specifier is associated with a rule, and wherein said rule is digitally signed by a sender of said message.
